(19) United States
(12) Patent Application Publication
(10) Pub. No.: US 2011/0213543 A1
(43) Pub. Date: Sep. 1, 2011

(54) INTEGRATION OF ELECTRONICS FUEL REGULATOR IN A SINGLE UNIT FOR 4 CYCLE ENGINES

(75) Inventors: James T. Bellistri, Wildwood, MO (US); Mazen A. Hajji, Chesterfield, MO (US)

(73) Assignee: PC/RC PRODUCTS, L.L.C., St. Louis, MO (US)

(21) Appl. No.: 12/994,954

(22) PCT Filed: May 28, 2009
(86) PCT No.: PCT/US09/45530

§ 371 Date: May 17, 2011

Related U.S. Application Data
(60) Provisional application No. 61/056,695, filed on May 28, 2008.

(51) Int. Cl. F02D 28/00; F02D 41/30

(52) U.S. Cl. 701/103

(57) ABSTRACT

A fuel injection system for a hydro carbon engine is provided with a simplified electronic governor system for controlling the maximum speed of the engine. The governor system is operatively associated with an electronic control unit (ECU) for operating the engine. A pulse width modulated fuel valve is provided with a pressure intensifier device enabling the fuel system to use low pressure signals in providing a fuel supply to the engine. The fuel system further is provided with a throttle body having the ECU, the fuel valve and the governor system integrated with on another in a single package for mounting on the engine.

### CROSS-REFERENCE TO RELATED APPLICATIONS

This application claims priority to U.S. Provisional Application Ser. No. 61/056,695, filed May 28, 2008, the specification of which is incorporated herein by reference.

### STATEMENT REGARDING COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND ART

This invention relates to electronic fuel injection systems for 4 stroke battery less single, and twin cylinder, hydro carbon engines. The system includes a low cost integrated solution to control the fuel injection of 4 cycle engines, and incorporates a number of features that enable those engines to operate at or near optimum performance characteristics despite changing load and environmental conditions.

Applicants' Assignee is the owner by assignment of U.S. patent application Ser. No. 12/375,898, filed Jan. 30, 2009 dealing with the application of certain techniques particularly applicable to 2 cycle engines. The specification of Ser. No. 12/375,898 is incorporated herein by reference. This disclosure deals with special problems associated with attempting to use low cost assemblies which may function well in 2 cycle engines, but which are not readily transferable in applicational use to 4 cycle engines.

### SUMMARY OF THE INVENTION

In accordance with this disclosure, generally stated, the preferred embodiment provides a totally integrated low pressure Electronic Fuel Injection System (EFI) and related components for 4 stroke battery-less, single cylinder or twin cylinder hydro carbon engines. The EFI system components includes: ECU hardware and software, Graphical User Interface (GUI), Fuel Injector, Throttle body with integrated fuel pump/intensifier and regulator, and required sensors (Throttle Position Sensor (TPS), Engine Temperature, Air intake Temperature, Engine Speed Sensor and electronic governor. The system is capable of communicating through conventional RS-232 connections using interface software (GUI) capable of monitoring, charting, calibrating, and modification of the system algorithm.

The foregoing and other objects, features, and advantages of the disclosure as well as presently preferred embodiments thereof will become more apparent from the reading of the following description in connection with the accompanying drawings.

### BRIEF DESCRIPTION OF THE DRAWINGS

In the accompanying drawings which form part of the specification:

FIG. 1 is a block diagram view showing one illustrative embodiment of control strategy for the system of the present invention;

FIG. 2 is a diagrammatic view of one preferred embodiment of Electronics Control Unit (ECU) employed with the system of FIG. 1;

FIG. 3A is a view in perspective of one illustrative embodiment of a power generating coil;

FIG. 3B is a view in perspective of one illustrative embodiment of the power generating coil of FIG. 3A integrated a regulator board employed with the power generating system of the present invention;

FIG. 3C is a view in perspective of one illustrative embodiment showing the integration of the fly wheel & power generation charging module.

FIG. 3D is a diagrammatic view showing one illustrative embodiment of the regulator board shown in FIG. 3(B) which allows the system of the present invention to provide maximum power available on the start up of the system and switch to low power during normal operation modes.

FIG. 4A is an exploded view of one illustrative embodiment of Fuel Pulse Pump assembly with a built in intensifier module which allows the fuel pump assembly in the illustrative embodiment to increase the motor crank case low pressure to higher pressure for proper fuel delivery wherein the value of the output pressure depends on the geometry of the intensifier and can result in substantial multiples of that pressure for engine operation;

FIG. 4B is a top plan view of the fuel pump shown in FIG. 4A; FIG. 4C is a sectional view taken along the line 4C-4C of FIG. 4B;

FIG. 5A is a view in perspective of one illustrative embodiment of integrated throttle body employed with the system of the present invention.

FIG. 5B is an exploded view of the integrated throttle body shown in FIG. 5A;

FIG. 6A is a diagrammatic view illustrating the closed loop control or the illustrative embodiment of electronic governor;

FIG. 6B is a diagrammatic view of the algorithm control for the electronic governor shown in FIG. 5A;

FIG. 6C is a diagrammatic view showing the response time for the electronic governor of the present invention;

FIG. 6D is a view in perspective showing one illustrative embodiment of a rotary solenoid employed with the electronic governor of the present invention;

FIG. 6E is a view in cross section showing one method of integrating the electronic governor with the throttle body of the system shown in FIG. 1;

FIG. 7A is a diagrammatic view showing a speed signal and a corresponding trigger signal illustrating control for and by the ECU enabling the system of the present invention to inject fuel every other cycle for a 4 stroke application.

FIG. 7B is a diagrammatic view illustrating various control signals used in the system of the present invention, including ignition timing, fuel injection timing, and throttle plate position as controlled by the electronic governor of the present invention.

Corresponding reference numerals indicate corresponding parts throughout the several figures of the drawings.

### BEST MODE FOR CARRYING OUT THE INVENTION

This disclosure relates generally to an electronic fuel regulation system, and more particularly, to an electronic fuel regulation system for small internal combustion engines, which in the preferred embodiment are four stroke engines of relatively small size, finding application, for example in power washers, small electrical generators and similar applications. While the invention is described in detail with respect to those applications, those skilled in the art will recognize the wider applicability of the inventive aspects described herein.

The following detailed description illustrates the present disclosure by way of example and not by way of limitation. It should be understood that various aspects of the disclosure may be implemented individually or in combination with one another. The description clearly enables one skilled in the art to make and use the development which we believe to be new and unobvious, describes several embodiments, adaptations, variations, alternatives, and uses of the system, including what is presently believed to be the best mode of carrying out the inventive principles described in this specification. When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

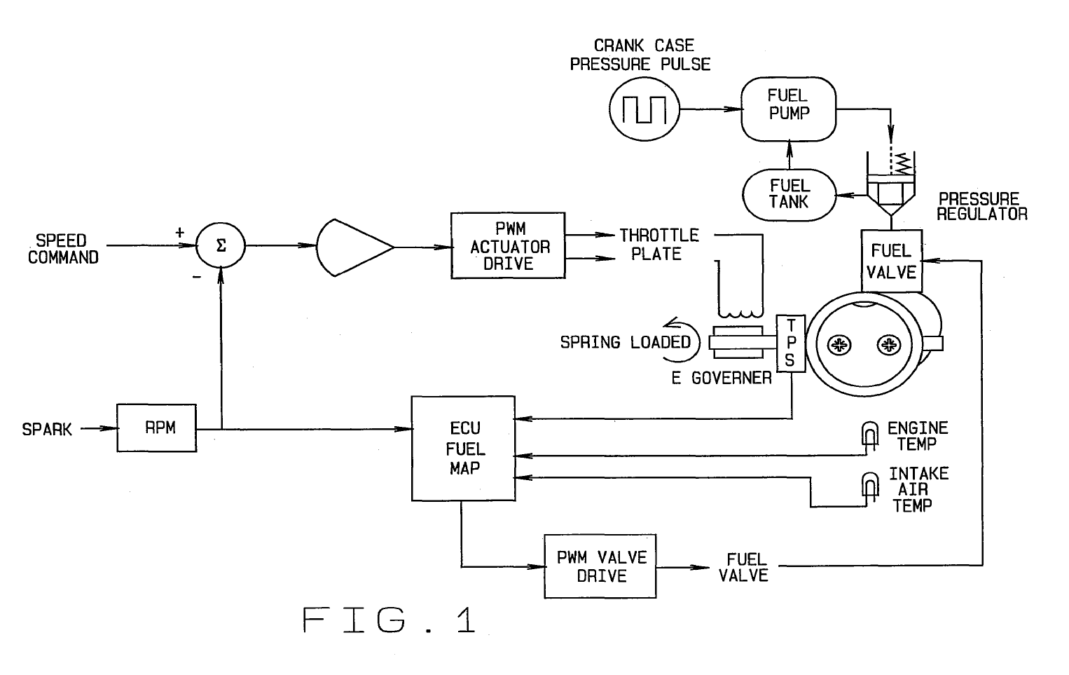

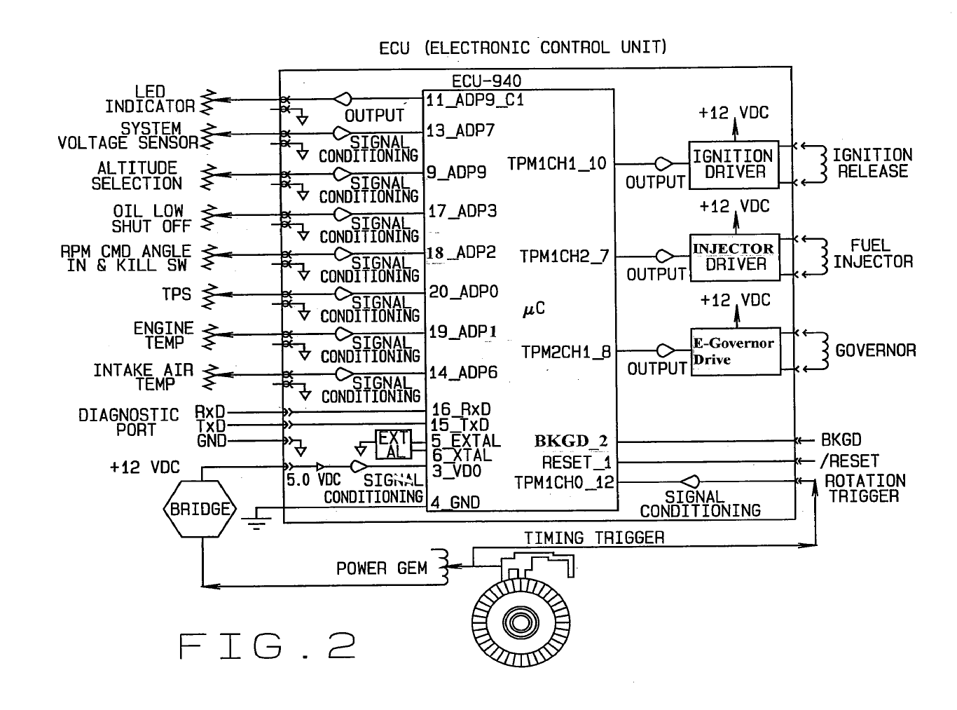

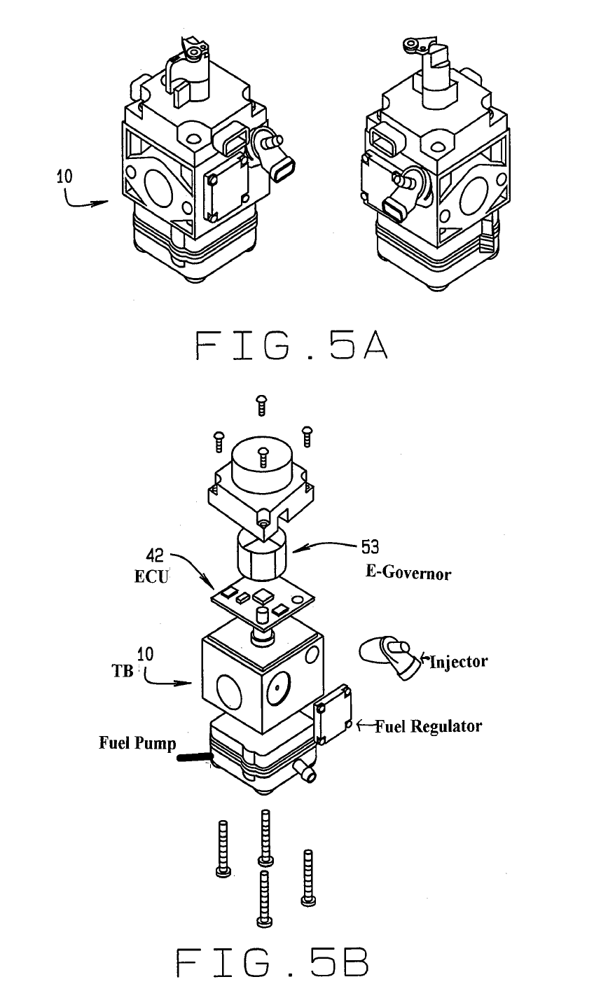

Referring to FIG. 1, reference numeral 1 indicates one illustrative embodiment of a fuel system for a four cycle engine in which the preferred embodiment of this disclosure as described below finds application. In particular, the present disclosure is intended to replace a carburetor system of prior art devices, and to achieve that replacement within the overall design silhouette of the prior art product configurations. The engine 2 has an engine block 12 containing a piston 11, and includes a fly wheel 3 (FIG. 2) attached to a crank shaft 7, which is initially operated by pulling a conventional rope pull during engine start. The illustrative example of the device in which the engine 2 finds application includes a fuel tank 4 having a supply line 5 from and a return line 6 to the tank 4. The supply line 5 is operatively connected to a throttle body 10 (FIG. 5A) and associated components, the integration of which is described in greater detail below.

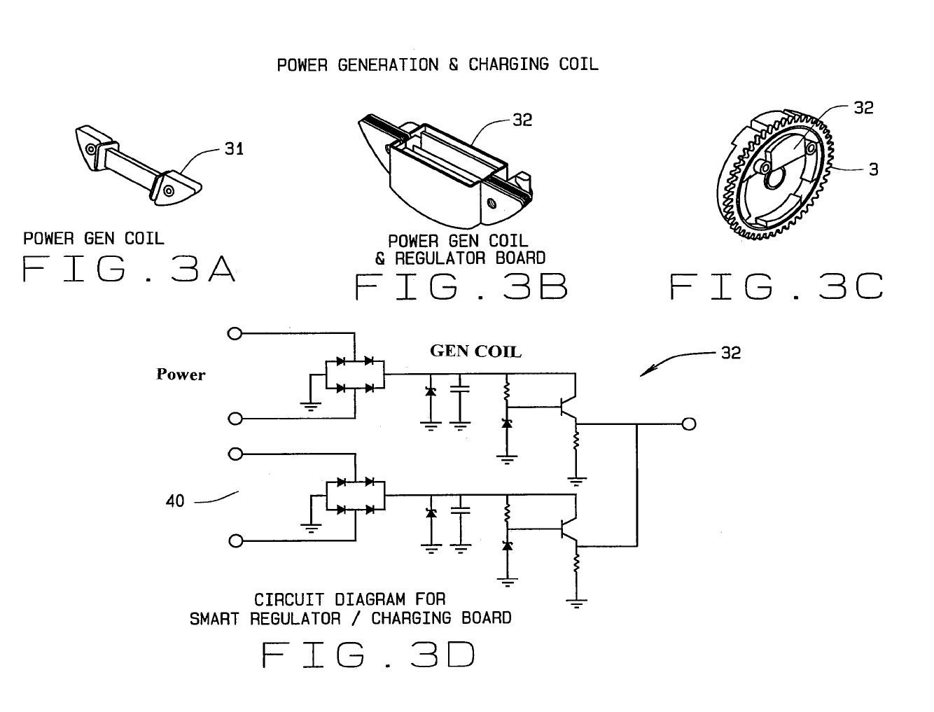

An electronic control unit (ECU hereinafter) 42 is utilized to control operation of the engine 2. In general terms, an ignition module 40 is associated with the fly wheel 3 for the purposes described in greater detail below. In any event, the ignition module 40 provides power to the ECU 42 and the ECU 42 preferably controls the operation of at least one injector 45 and spark timing and consequentially the ignition and the fuel in a chamber 14 based on a number of parameters discussed below. The module 40 includes a power generating coil 31, (FIGS. 3A-3D) mounted to a regulation board 32. The fly wheel 3 has a magnet associated with it and rotation of the fly wheel permits the module 40 to power the ECU 42. Among the inventive principles of the present disclosure is how this operation is accomplished in minimal space requirements, reliably over the life of the engine 2, and at a cost competitive with present carburetor designs of the prior art. We accomplish this with an integrated approach.

Referring now to FIG. 5A, the throttle body 10 of the preferred embodiment includes a housing 100 adapted to have a plurality of components attached to it. As indicated, the integration of the throttle body 10 is an important feature of this disclosure, in that it permits substitution of the fuel system 1 described herein for prior art carburetor type systems with little modification of the overall product configuration in which the system described herein finds application. The throttle body housing 100 of the throttle body 10 is preferably constructed of a plastic material; however other materials such as aluminum, for example, may be employed in various embodiments of the disclosure.

The housing 100 of the throttle body 10 has the electronic control unit (ECU) 42, pump assembly 84b, a primer assembly 29, the fuel injector assembly 45, a throttle assembly 13, a fuel pressure regulator assembly 20, and an electronic governor 61 all mounted to it. If desired, these components all can be pre assembled to the throttle body 10, and the overall assembly then attached to the engine 2. As will be appreciated by those skilled in the art, the throttle body 10 has a number of internally arranged passages formed in it, which together with the various components described herein, are adapted to control fuel flow among the various components and primarily to the combustion chamber 14 for operating the engine 2. The passages include an intake air temperature sensor passage which permits an air temperature sensor 167 mounted to a circuit board 60 of the ECU 42 to ascertain intake air temperature reliably. While a particular design shape is illustrated for the housing 100 of the throttle body 10, other design silhouettes may be used, if desired.

As will be appreciated by those skilled in the art, this disclosure provides an integrated low pressure electronic fuel injection system for a 4 stroke, battery less single or twin cylinder gasoline engine. The system components include the ECU 42 hardware, software, a graphical user interface, fuel injector assemble 45, throttle body 10 with integrated fuel pump intensifier and regulator 20 and required sensors which many include by way of example, a throttle position sensor (tps) 50 an engine temperature sensor 51, the air intake temperature sensor 167, an engine speed sensor 52 and an electronic governor 53.

As shown in FIG. 2, the ECU 42 of the present disclosure is powered by a power generation circuit 25. Merely rotating the flywheel of the engine 2 enables the system 1 to generate sufficient electrical energy to power the ECU and the initial control sequences for the engine 2. We have consistently started engines with a minimum number of rope pulls both to start and operate the engine under all present test conditions for similar applications. A bridge circuit 36 shown in FIG. 3D provides these capabilities at reasonable cost.

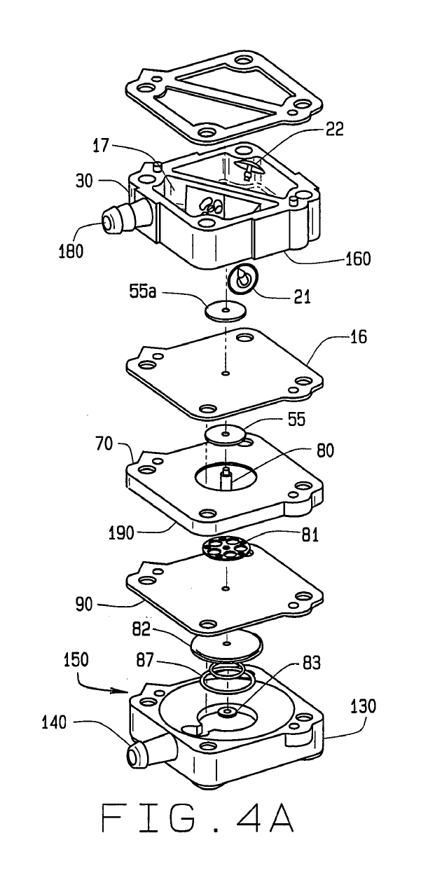

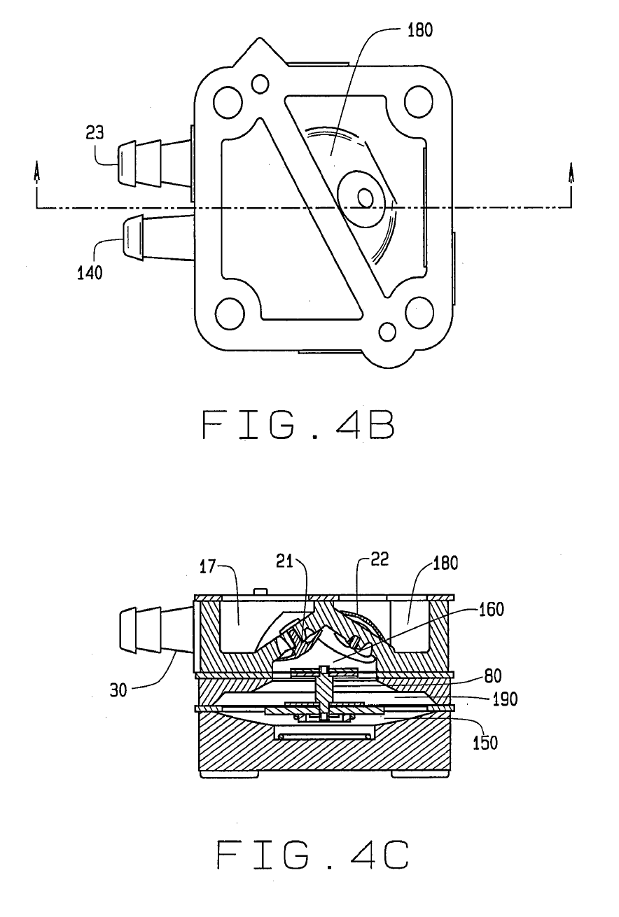

Referring now to FIG. 4A, the ECU 42 controls operation of the engine 2 by sensing the operating conditions in which the engine is operating and, based on those observations, controlling the fuel supply to the engine in conjunction with several unique components. Among these is the integrally arranged fuel pump 20 for supplying fuel to the engine 2. The pump, 20 as shown in FIG. 4 (A-C) consists of 3 main parts. These parts are the fuel pump body (30); a reducer plate (70) and a pump air chamber base (130). Associated with each of the main parts are their respective chambers. An air chamber (150) is formed by pump air chamber base (130) and an air chamber diaphragm (90). Air chamber (150) is connected to any portion of the engine (2) that produces a pressure wave consistent with that of the engine rotation. At least two sources have proved acceptable. These are the crankcase of the engine (2) and the air intake for the engine. We preferably use the crankcase pulse, but those skilled in the art recognize that other acceptable pulses may be used. The pressure pulses are then transmitted to the air chamber inlet (140) and into the air chamber (150). These pulses consist of both positive and negative pressure waves; however modern engines utilize a breather that is fitted with a breather check valve (not shown) that restrict the air in one direction such as to create a generally negative pressure inside the crankcase. In order to accommodate for the generally negative pressure the air chamber diaphragm (90) has attached to it an intensifier pin (80), a disk washer (81), a spring cap (82), a spring cap washer (83), and a spring (87) that biases the air chamber diaphragm (90) opposite to the negative pressure thereby acting to reset the Air chamber diaphragm (90) when the pressure wave begins to become positive. This pressure differential and spring reset of the air chamber diaphragm (90) create motion that is transmitted to the intensifier pin (80) which travels through a reducer plate (70) and is connected to the fuel pump diaphragm (16). The reducer plate (70) has two differing diameters. Preferably a larger diameter at the Air chamber (150) side and a smaller diameter at the fuel pump chamber (160) side. This combination then operates to intensify low pressure from the crankcase to an acceptable pressure for use in the fuel system (1). The reducer chamber (190) is necessary to accommodate the differences in diameter between the air chamber (150) and the fuel pump chamber (160). The fuel pump diaphragm (16) is moved by the intensifier pin (80). Motion is transmitted from the intensifier pin (80) onto the fuel pump diaphragm (16). When the fuel pump diaphragm (16) moves, pressure waves are created in the fuel pump chamber (160) and fuel is directed in one direction by the fuel pump chamber outlet check valve (22) and the fuel pump chamber inlet check valve (21). Fuel is supplied to the fuel pump inlet (23) from the fuel tank (4) and is transmitted into a Fuel pump inlet chamber 17. When the pressure inside the fuel pump chamber (160) becomes low, the Fuel pump chamber inlet check valve 21 opens and fuel moves from the fuel pump inlet chamber 17 into the fuel pump chamber (160). When the motion of the of the fuel pump diaphragm (16) is reversed, the pressure in the fuel pump chamber (160) causes the fuel pump chamber inlet check valve (21) to close and the fuel pump chamber outlet check valve (22) to open. Fuel is then moved from the fuel pump chamber (160) into the fuel pump outlet chamber (180) and the process is complete and ready to begin again. The ability to use a weak signal pulse to operate and provide fuel to the engine 2 in one of the important concepts of the present disclosure.

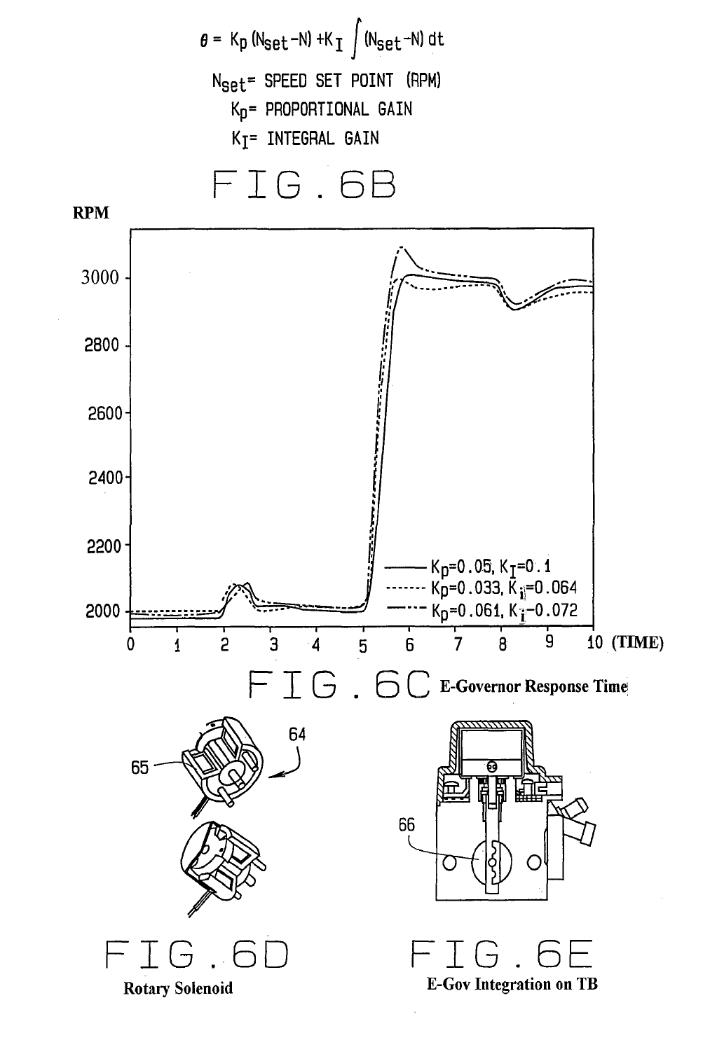

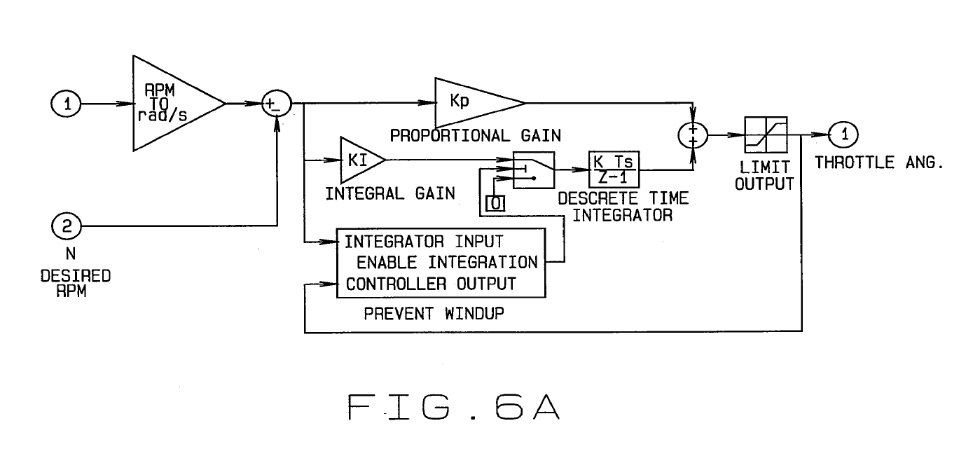

Another feature of this disclosure is the incorporation of electronic governor 60 control to engine speed. The control loop for the electronic governor 60 (FIG. 6A) includes of an input desired RPM, a PI control loop, a calculated RPM measurement, followed by a linearization stage producing a throttle angle command. The input desired RPM command can be either a static value such as required for 50 Hz/60 Hz generators, ie 3000 RPM/3600 RPM, or can be a dynamic command from the user. In either case the control loop will create the throttle angle command which will force the RPM error to zero.

The electronic governor control loop is computed digitally in the ECU 42 microprocessor. Utilizing a proportional gain (Kp) multiplied by the sampled RPM error (Nset−N) and an integral gain (Ki) multiplied by the accumulated RPM error (Nset−N) dt allows the microcontroller to constantly adjust the operating point while constantly minimizing the RPM error. FIG. 6C shows the simulated control loop response to a change in the RPM command from 2000 RPM to 3000 RPM.

The throttle angle command from the PI loop is linearized prior to input to the PWM generator to compensate for the non-linear response of a rotary solenoid 64 (FIG. 6D). This is necessary as some rotary solenoids require less drive per degree of movement at the closed position as compared to the degree of movement at the near wide open throttle position. This is primarily caused by a return spring 65 of the rotary solenoid 64. The linearized throttle angle command is then passed to the pulse width modulation block where the command is converted to a series of pulses with varying pulse width used to drive the rotary solenoid 64 which is operatively connected to a throttle plate 66. In this manner, engine 2 speed is controlled electronically without the need for mechanical governed arrangements of the prior art.

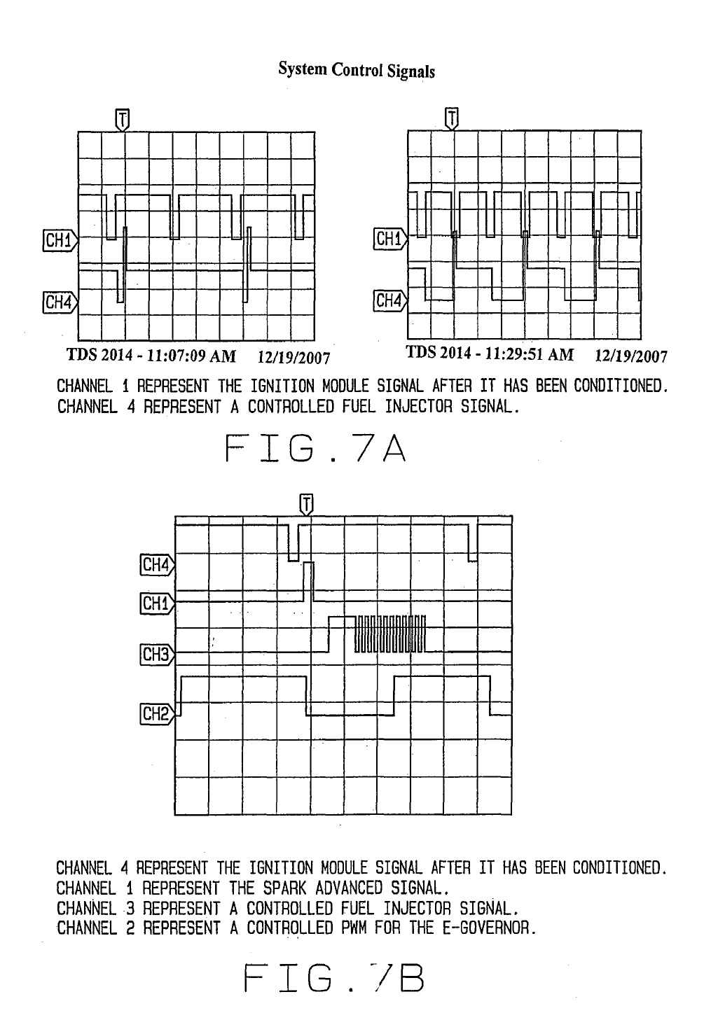

As will be appreciated by those skilled in the art, operational signals received by and generated by ECU 42 in controlling the various operations of the system 1 are illustratively shown in FIGS. 7A and B.

A number of variations to the implementation can be made which produce similar results for the electronic governor. For instance, 1) the rotary solenoid could be replaced by a stepper or DC motor, 2) to achieve a higher bandwidth in the control loop, an inner PI or PID control loop utilizing the throttle angle command and throttle position sensor feedback can be implemented, 3) the throttle plate PWM drive signal could be replaced with an H bridge drive or analog drive signal, 4) the micro-processor could be replaced with a DSP (digital signal processor), FPGA (field programmable gate array), or other computational device, 5) The control loop could be implemented using a proportional only term, for example.

As will be appreciated by those skilled in the art, aspects of the present disclosure can be embodied in the form of computer-implemented processes and apparatuses for practicing those processes. The aspect of the present disclosure can also be embodied in the form of computer program code containing instructions embodied in tangible media, such as floppy diskettes, CD-ROMs, hard drives, or an other computer readable storage medium, wherein, when the computer program code is loaded into, and executed by, an electronic device such as a computer, micro-processor or logic circuit, or other form of ECU, the device becomes an apparatus for practicing the invention.

In view of the above, it will be seen that the several objects of the disclosure are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A fuel injection system for a 4 cycle engine, comprising:
an ECU for controlling operation of the injection system, the ECU receiving engine temperature and intake air temperature, throttle position and engine speed as inputs and providing control to a pulse width modulated fuel valve; and
an electronic governor system for controlling maximum speed of the engine operatively associated with the ECU.

2. A fuel injection system for a 4 cycle engine, comprising:
a throttle body having an integrated fuel pump and regulator associated with the throttle;
an electronic control unit having an algorithm stored in a non volatile memory; and
an electronic governor system for controlling maximum speed of the engine operatively controlled by the electronic control unit.

3. A fuel injection system for a hydro carbon engine, comprising:
an ECU for controlling operation of the injection system, the ECU receiving engine condition signals and providing control to a pulse width modulated fuel valve, the fuel valve having an input side and an output side, the output side providing fuel at a higher pressure than fuel received at the input side, and an intensifier device for increasing fuel pressure mounted internally of the fuel pump.

4. A fuel injection system for a hydro carbon engine, comprising:
a throttle body operatively mounted to the engine,
an ECU for controlling operation of the injection system mounted to the throttle body, the ECU receiving engine condition signals and providing control to a pulse width modulated fuel valve,
a fuel valve having an input side and an output side mounted to the throttle body and being operatively connected to the ECU, the output side of the fuel valve providing fuel at a higher pressure than fuel received at the input side, and
an intensifier device for increasing fuel pressure mounted internally of the fuel pump.

5. A fuel injection system for a hydro carbon engine, comprising:
a throttle body operatively mounted to the engine,
an ECU for controlling operation of the injection system mounted to the throttle body, the ECU receiving engine condition signals and providing control to a pulse width modulated fuel pump,
a fuel pump having an input side and an output side mounted to the throttle body and being operatively connected to the ECU, the output side of the fuel pump providing fuel at a higher pressure than fuel received at the input side,
an intensifier device for increasing fuel pressure mounted internally of the fuel pump, and
a electronic governor operatively connected to the ECU, the electronic governor controlling speed of the engine

6. A fuel system for a hydro carbon engine, comprising:
an ECU for controlling operation of the fuel system;
an electronic governor operatively connected to the ECU, the electronic governor controlling speed of the engine by adjusting fuel input to the engine.
